(19) United States
(12) Patent Application Publication
(10) Pub. No.: US 2006/0224815 A1
(43) Pub. Date: Oct. 5, 2006

(54) Virtualizing memory management unit resources

(76) Inventors: Koichi Yamada, Los Gatos, CA (US); Gary Hammond, Fort Collins, CO (US)

Correspondence Address: TROP PRUNER & HU, PC, 1616 S. VOSS ROAD, SUITE 750, HOUSTON, TX, 77057-2631, US

(21) Appl. No.: 11/093,702

(22) Filed: Mar. 30, 2005

(51) Int. Cl. G06F 12/00

(52) U.S. Cl. 711/6; 711/205

(57) ABSTRACT

In one embodiment, the present invention includes a method of intercepting a guest software execution of a translation insertion operation, and performing the translation insertion operation using host software. For example, the host software may obtain a requested translation from a guest virtual address to a host physical address and provide it to memory management unit resources. Other embodiments are described and claimed.

### BACKGROUND

The present invention relates to optimizing memory management, and more specifically to optimizing such memory management in a virtual machine environment.

A virtual machine monitor (VMM) is software that runs on a computer system and presents to other software the abstraction of one or more virtual machines. That is, a VMM is software that is aware of virtualization processor/platform architecture and implements policies to virtualize and manage shared hardware resources. Virtualization refers to methodologies to share or replicate hardware resources among multiple instances of virtual machines or guest software. Sharing or replication of the hardware resources must be transparent to the guest software. Virtualization creates the illusion to the guest software such that guest software expects to own all hardware resources.

A virtual machine (VM) or guest is an environment that refers to virtualized resources. The guest may function as a self-contained platform, running its own operating system (i.e., a guest operating system (OS)) and other software, collectively referred to as guest software (or simply a guest). The guest software is said to be hosted by the VMM and to be running on virtualized resources. The guest software expects to operate as if it were running on a dedicated computer rather than a virtual machine. Accordingly, the guest software expects to control various events and have access to hardware resources, such as processor-resident resources (e.g., control registers), resources that reside in memory (e.g., various tables) and resources that reside on the underlying hardware platform (e.g., input/output (I/O) devices).

Virtual machine technology allows multiple instances of operating systems (guest OS's) to run on a single computer system by virtualizing the hardware resources including processors, memory and I/O devices. One of the key virtualization issues for a VMM is how to virtualize the memory and the processor's memory management unit (MMU) resources, including a translation lookaside buffer (TLB) and hardware walker resources for each guest software execution environment.

This is especially so, as the VMM may need to create and run multiple guest OS execution environments simultaneously and may need to create a similar platform memory address layout view to each guest software execution environment. In another example, the VMM may need to create the illusion of a larger amount of physical memory space to a guest OS execution environment than the actual amount of main memory available on the platform. The VMM also needs to prevent direct guest access to physical memory for security reasons and should also prevent one guest from accessing physical memory belonging to a different guest.

To meet the above requirements of creating virtualized physical memory mappings for a guest OS execution environment, the VMM needs to implement an extra layer of address conversion logic that translates from a guest physical address to a host physical address when a guest virtual address is translated to a guest physical address through a TLB. This is called “MMU (TLB) virtualization”. However, the conversion logic requires complex hardware, is cumbersome and is incompatible with off-the-shelf software, such as shrink-wrap operating systems.

A need thus exists to improve execution of guest software in a virtual machine environment.

### BRIEF DESCRIPTION OF THE DRAWINGS

FIG. 1 is a block diagram of a system having a virtual machine environment in accordance with one embodiment of the present invention.

FIG. 2 is a flow diagram of a method of translating addresses in accordance with one embodiment of the present invention.

FIG. 3 is a block diagram of a portion of a system in accordance with an embodiment of the present invention.

FIG. 4 is a block diagram of a multiprocessor system in accordance with an embodiment of the present invention.

### DETAILED DESCRIPTION

In various embodiments a VMM (also referred to herein as a “host”) may trap and remap processor TLB entries transparently to a guest OS. Furthermore, a VMM may intercept TLB initialization and run time events, such as TLB miss faults and the like. The VMM may also create data structures in memory to provide for additional storage of address translations. In one such embodiment, a data structure may include a virtual hash page table (VHPT) which may be implemented using a system VHPT page walk mechanism.

To accommodate the above operations, a VMM stack may include additional software to perform these functions and to provide for emulation/management capabilities. Such emulation/management capabilities may be supported using a standard virtualization intercept mechanism (e.g., a VM hardware trapping mechanism).

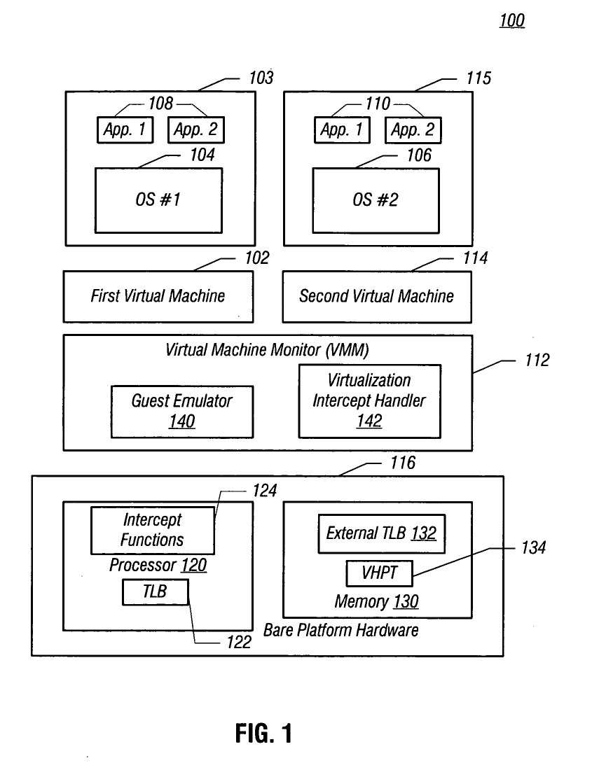

Referring now to FIG. 1, shown is a block diagram of a system having a virtual machine environment in accordance with one embodiment of the present invention. In the embodiment of FIG. 1, virtual machine environment 100 includes bare platform hardware 116 that may be a computing platform, such as any type of computer system, and which may execute a standard operating system (OS) or a virtual machine monitor (VMM), such as a VMM 112. VMM 112 may emulate and export a bare machine interface to guest software. Such higher-level software may be a standard (i.e., shrink-wrap) or real-time OS, an operating environment with limited operating system functionality, or the like. Alternately, VMM 112 may be run within or on top of another VMM.

Platform hardware 116 may be of a personal computer (PC), server, wireless device, portable computer, set-top box, or any other computing system. As shown in FIG. 1, platform hardware 116 includes a processor 120, memory 130 and may include other platform hardware (e.g., I/O devices) not shown in FIG. 1.

Processor 120 may be any type of processor capable of executing software, such as a microprocessor, digital signal processor, microcontroller, or the like. Processor 120 may include microcode, programmable logic or hardcoded logic for performing methods in accordance with embodiments of the present invention. Although FIG. 1 shows only one such processor 120, there may be one or more processors included in platform hardware 116. As an example, processor 120 may be a chip multiprocessor (CMP) or another multiprocessor system, such as a common system interface (CSI) multiprocessor system.

As further shown in FIG. 1, processor 120 includes a translation lookaside buffer (TLB) 122. TLB 122 may include multiple TLB's, such as an instruction TLB and a data TLB. Such TLBs store recently used translations from virtual addresses to physical addresses to avoid time-consuming accesses to main memory (e.g., memory 130) to obtain the information. Processor 120 further includes intercept functions 124, which are used to intercept certain actions undertaken by a guest, as will be described further below. In other words, intercept functions 124 include the virtualization intercept mechanisms of processor 120.

Memory 130 may be a hard disk, a floppy disk, random access memory (RAM) such as dynamic RAM (DRAM), read only memory (ROM), flash memory, any combination of the above devices, or any other type of medium accessible by processor 120. Memory 130 may store instructions and/or data for performing embodiments of the present invention. Furthermore, as will be discussed further below, memory 130 may include an external TLB 132 to store certain address translations and other information. In one embodiment, external TLB 132 may be implemented as a VHPT, using a processor's VHPT walker to access the structure in memory. Furthermore, a VHPT 134 associated with a guest operating system may also be present, in some embodiments.

VMM 112 presents to other software (i.e., guest software) the abstraction of one or more virtual machines (VMs). VMM 112 may provide the same or different abstractions to the various guests. While FIG. 1 shows two such VMs 102 and 114, it is to be understood that more or less than two VMs may be supported by VMM 112. The guest software running on each VM may include a guest OS such as a guest OS 104 or 106 and various guest software applications 108 and 110. Collectively, guest OS and software applications are referred to herein as guest software 103 and 115.

Guest software 103 and 115 expect to access physical resources (e.g., processor registers, memory and I/O devices) within VMs 102 and 114 on which the guest software 103 and 115 is running. VMM 112 facilitates access to resources desired by guest software 103 and 115 while retaining ultimate control over resources within platform hardware 116. The resources that guest software 103 and 115 may attempt to access may either be classified as “privileged” or “non-privileged.” For privileged resources, VMM 112 facilitates functionality desired by guest software 103 and 115 while retaining ultimate control over these privileged resources. Non-privileged resources do not need to be controlled by VMM 112 and can be accessed directly by guest software 103 and 115.

Further, guest software 103 and 115 expect to handle various fault events such as exceptions (e.g., page faults, general protection faults, traps, aborts, etc.), interrupts (e.g., hardware interrupts and software interrupts), and platform events (e.g., initialization (INIT) and platform management interrupts (PMIs)). Some of these fault events are “privileged” because they are to be handled by VMM 112 to ensure proper operation of guest software 103 and 115 and for protection from and among guest software.

Privileged and non-privileged events that include exceptions, interrupts and platform events are referred to herein as faults. The term fault is used regardless of the semantics of the event with regard to the point at which the fault is detected; the detection may occur during or following execution of an instruction, prior to, during or following the delivery of an event, and the like. A fault may be generated by execution of an instruction on processor 120 such as a TLB insertion instruction, or by events within processor 120 or external to it. For example, an instruction that accesses memory 130 may cause a variety of faults due to paging mechanisms.

In such manner, VMM 112 may obtain control when certain virtualization events occur while running in guest software. These virtualization events may include faults (e.g., TLB miss faults, interrupts, exceptions, and platform events) or the execution of instructions which access privileged resources (e.g., move to/from control register, halt, move to/from debug register, cache and certain TLB instructions, and the like).

A VMM may detect that a guest is taking certain actions (e.g., is executing a privileged instruction or is writing to a certain physical memory location) or may detect certain faults. These guest software actions or events may cause a VM exit (i.e, transfer of control) to the VMM.

Certain embodiments may be implemented in software and may include a guest emulator 140, which may be implemented as part of VMM 112. Guest emulator 140 may virtualize certain resources of the guests operating on the platform. For example, guest emulator 140 may utilize intercept functions 124 of processor 120 to enable various emulation/management functions. VMM 112 may further include a virtualization intercept handler 142. Virtualization intercept handler 142 may be VMM code to handle certain activities upon interception of a guest. In one embodiment, virtualization intercept handler 142 may include code to perform TLB functions normally executed by a guest.

In one embodiment, a VM exit may occur when a TLB miss occurs in a guest. As an example, upon such a TLB miss (meaning that a desired translation from a guest virtual address to a host physical address is not present in the processor TLB) a guest may seek to execute a TLB insertion instruction in order to obtain the requested translation through a page table walk or other such mechanism. The execution of such an instruction on a guest may cause a virtualization intercept, leading to a VM exit and control passing to the VMM. There, the TLB insertion instruction may be delivered to a virtualization vector in the host interrupt vector table (IVT). In one embodiment, such a VM exit may occur by first setting a control mechanism. For example, a VM bit in a processor status register (PSR) may be set to cause a virtualization intercept upon the guest execution of the TLB insertion instruction.

Still further, the VMM may intercept guest access to control registers that control page table mechanisms. For example, the VMM may intercept guest writes/reads on the page table address (PTA) register, which controls the hardware page table walker of the processor. More so, in some embodiments the VMM may intercept TLB insertion service events from a guest. Such TLB insertion events may include TLB miss faults and VHPT miss faults, if a guest has configured a VHPT for storage of translations. In one embodiment, the VMM may intercept such events by allowing the VMM to take ownership of the guest's IVT.

Because interception of these various guest events may impact performance of guest code execution and increase TLB miss rates, an external TLB may be formed in system memory. That is, to mitigate TLB virtualization overheads, the VMM may build an external TLB in memory to hold guest virtual address to host physical address translations. In one embodiment, the external TLB may be implemented as a form of an architected page table walk in the processor architecture. For example, the VMM may construct a memory buffer where the processor's hardware walker can be configured to search for a translation after a failed TLB search. For example, the processor may allow the VMM to construct a virtual hash page table (VHPT) and use a processor hardware VHPT walker to search for a requested translation after a TLB miss in the processor. Furthermore, the VMM can insert converted translations to this external TLB buffer memory in addition to inserting them into the TLB.

In some embodiments, the VMM may disable a guest's use of a processor's hardware page table walker and provide emulation services upon guest TLB miss events. In one embodiment, the VMM may set control registers to disable guest use of the hardware page table walker.

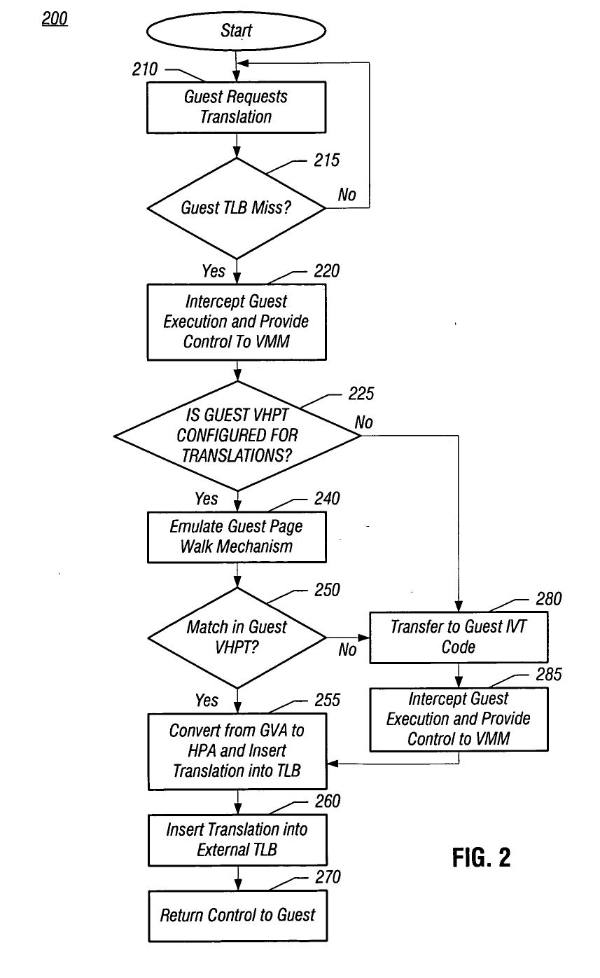

Referring now to FIG. 2, shown is a flow diagram of a method in accordance with one embodiment of the present invention. More specifically, method 200 may be used to obtain translations requested by a guest, when they are unavailable in the guest TLB. Method 200 begins by a guest requesting a translation (block 210). The guest may request a translation from a guest virtual address (GVA) to a host physical address (HPA). The guest may first search for such translation in the processor's TLB, which stores GVA to HPA translations. If the requested translation is found there, the guest may continue normal operation without further performance of method 200. If the address is not located in the processor's TLB and the VMM has enabled the VHPT for enabling an external TLB buffer in memory, it may also access the VHPT to determine if the requested translation is present there. Note that while described herein as a VHPT, it is to be understood that a different memory structure external to a processor may be used to store additional address translations.

If the requested translation is not present in either the TLB or the VHPT (if enabled), a guest TLB miss occurs. Upon the determination of a guest TLB miss (diamond 215), guest execution is intercepted and control is provided to the VMM (block 220). In one embodiment, the processor may generate a virtualization intercept fault and hand off to a VMM virtualization intercept handler to handle the virtualization intercept fault. The VMM may first check if the guest software configures the VHPT for its own TLB optimization. That is, the VMM may determine whether the guest VHPT is configured for translation search and insertion (diamond 225). If so, the VMM emulates the guest hardware page table walk on the guest VHPT (block 240). Further, the VMM determines whether there is a translation match (i.e., GVA to GPA translation) in the guest VHPT (diamond 250).

When a matching translation for the guest virtual address is found in the guest VHPT, the VMM extracts a guest physical address from that translation entry and converts it to a host physical address (HPA) (block 255). The VMM then constructs a GVA to HPA translation and inserts it into the TLB (also block 255), as well as to the external TLB (e.g., an external VHPT that caches GVA to HPA translations). Then, the VMM returns control to the guest (i.e., via a VM enter operation) (block 270). Thus guest software execution resumes, causing the processor to re-execute from the faulted guest memory reference instruction. Of course, now the requested memory reference translation is available in the TLB.

Still referring to FIG. 2, if instead at diamond 225 it is determined that the guest VHPT is not configured for translation search and insertion or there is no match in a translation-enabled guest VHPT (at diamond 250), control passes to block 280. There, the VMM transfers control back to the guest (block 280). More specifically, a VM entry occurs and the guest IVT is accessed to execute guest IVT code for a TLB miss. That is, when the guest VHPT is not enabled or a matching guest translation entry is not found in the guest VHPT, the VMM allows guest IVT code to handle the TLB miss in the guest execution environment. When the guest IVT code for TLB misses executes an insert translation cache (ITC) instruction, it is intercepted by the VMM with a virtualization intercept fault (block 285). Thus control again passes to the VMM via a VM exit.

In one embodiment a guest ITC instruction is intercepted with two operands: 1) guest virtual address (GVA) to translate from; and 2) guest physical address (GPA) to translate to. Upon interception of the guest TLB insertion instruction, the VMM first may check the validity of the GPA to ensure its correctness and enforce protection and isolation of the physical memory space. Second, it may perform an address conversion from the GPA to a host physical address (HPA) with a VMM specific conversion algorithm (block 255). Lastly, it constructs and inserts a page translation to the TLB, which translates from the GVA to the HPA (also block 255). As discussed above, the translation may also be stored in the external TLB (block 260), and control passes back to the guest (block 270).

The complexity of this GPA to HPA conversion algorithm may depend on the VMM's guest physical memory virtualization requirements. Certain VMM's choose to coarsely partition the physical memory among the multiple guests. Accordingly, a GPA to HPA conversion algorithm may add the guest physical offset and the base address of the partitioned memory together. Some VMM's allow a guest to oversubscribe the amount of the physical memory and perform page-in and page-out of the guest physical memory and maintain a sophisticated guest to host physical address conversion table.

Even when a guest OS already has utilized the VHPT for its own TLB optimizations, the processor may allow the VMM to take over the actual VHPT hardware resources from the guest and virtualize the guest VHPT resources through emulation upon interception of guest accesses to the control registers that control the VHPT hardware walker. With this external TLB buffer, the VMM can effectively cache more GVA-to-HPA translations in memory. In such manner, software TLB miss rates from the guest may be reduced, and the frequency of intercepting the guest TLB insertion instructions may also be reduced. Accordingly, the overhead of the MMU (TLB) virtualization costs may be minimized.

The VMM may implement additional MMU virtualization optimizations by providing software emulation of the guest hardware page table walk mechanisms upon interception of the guest TLB miss IVT events. Emulation by the VMM may significantly reduce the frequency of executing the guest OS's TLB miss handler code, greatly reducing the path length of the guest software. Further, the guest low-level TLB miss handler code often contains many privilege instructions, which generate virtualization intercepts to the VMM for emulation services. Thus, reducing the frequency of running the guest low-level TLB miss handler code may reduce the total number of instructions to be executed by the guest and host software for servicing TLB misses, improving guest code execution.

Embodiments of the present invention can also be applied to virtualize guest physical memory accesses when the guest software is running in physical mode. As the TLB is used to convert from a GPA to HPA, the host software component of the VMM may enable the TLB and emulate the guest physical memory references with the virtual translation enabled. When the guest software references a physical memory in the emulated physical mode, it may generate a TLB miss and the host software component intercepts the TLB insertion service IVT event. The host software component then implements the same algorithms described above for GPA to HPA conversion. However, the host software component can treat the GPA described above as a GVA when the guest is running in physical mode.

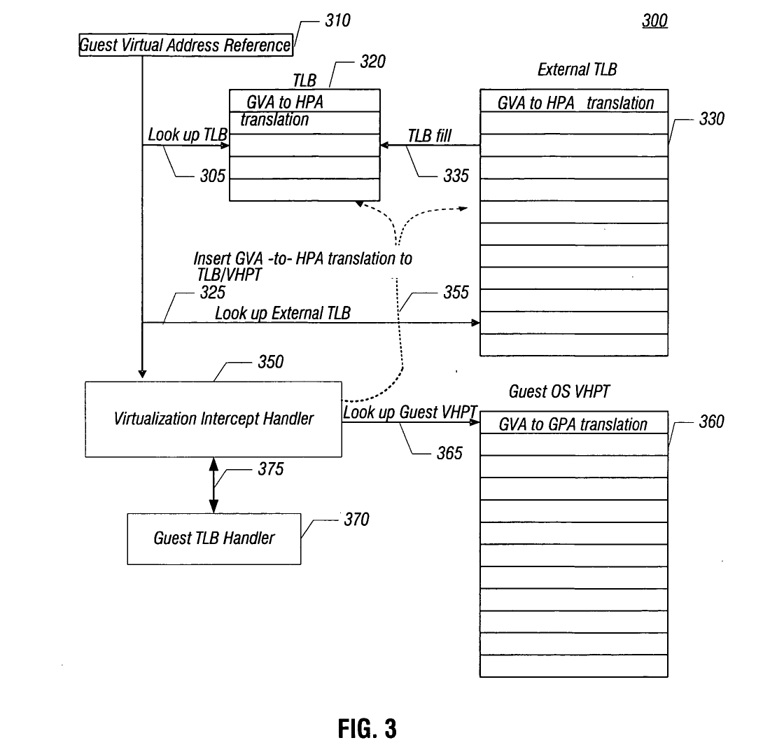

Referring now to FIG. 3, shown is a block diagram of a portion of a system in accordance with one embodiment of the present invention. More particularly, FIG. 3 shows a portion of a system 300 that includes various hardware resources, along with software to enable a VMM to emulate guest page walk mechanisms. As shown in FIG. 3, the hardware resources may include a TLB 320 that is used to store GVA to HPA translations. TLB 320 may be part of a memory pipeline of a processor, for example, processor 120 of FIG. 1. More specifically, TLB 320 may correspond to TLB 122 of FIG. 1. Furthermore, an external TLB 330 is present. External TLB 330 may be used to store GVA to HPA translations. As an example, the external TLB 330 may be a VHPT set up by a VMM. With reference back to FIG. 1, external TLB 330 may correspond to external TLB 132 of FIG. 1. Still further, in embodiments in which a guest OS optimizes its TLB, a guest OS VHPT 360 may be present to store GVA to GPA translations. This additional buffer 360 may also reside in system or main memory (e.g., VHPT 134 of FIG. 1).

FIG. 3 also shows various software components used in emulating TLB functions. As shown in FIG. 3, a virtualization intercept handler 350 may be provided to intercept guest execution and perform various routines. In the context of TLB misses, virtualization intercept handler 350 may emulate guest hardware page walk mechanisms. Still further, a guest TLB handler 370 may be executed, which is the guest IVT code to handle TLB misses in the guest execution environment.

Further shown in FIG. 3 are the conceptual flows of translating from a guest virtual address (GVA) to a host physical address (HPA). On a memory reference by the guest software (block 310), a TLB lookup (line 305) searches TLB 320 for a matching translation entry to translate from a GVA to a HPA. When a matching translation is entry is found in TLB 320, the processor generates a HPA from the matching translation and references to a host physical address location.

If however, a matching translation entry is not found in TLB 320, the processor may search external TLB 330 for the translation (via lookup line 325). When a matching translation entry is found in external TLB 330, the processor installs that matching translation into TLB 320 (on TLB fill line 335) and uses it for addressing to a host physical address location.

If a matching translation is not found in either of TLB 320 or external TLB 330, the VMM takes control from the guest and executes virtualization intercept handler 350. As discussed above, virtualization intercept handler 350 emulates the guest's hardware page walk mechanism and searches the guest OS VHPT 360 for a matching GVA to GPA translation using lookup line 365. If the translation is found, virtualization intercept handler 350 converts from the GPA to an HPA and inserts a GVA-to-HPA translation to TLB 320 and external TLB 330 via fill line 355. Referring now to Table 1, shown is an example code portion implementing the functionality of virtualization intercept handler 350.

TABLE 1

```
Virtualization Intercept Handler ( )
If (Emulate Guest VHPT)
  Walk and search the guest VHPT;
  If (found)
    Convert from GPA to HPA;
    Insert a GVA-to-HPA translation
      to TLB and VHPT;
    Exit;
```

Control then returns to the guest for replay of the instruction so that the translation may be obtained.

If instead there is no matching entry in guest VHPT 360, virtualization intercept handler 350 returns control back to guest TLB handler 370 via a VM enter operation, represented by directional arrow 375 between virtualization intercept handler 350 and guest TLB handler 370. As described above, guest TLB handler 370 performs an insert translation cache (ITC) instruction, which is intercepted by virtualization intercept handler 350. Using the GPA obtained from the ITC instruction, virtualization intercept handler 350 converts from a GPA to an HPA and forms a GVA-to-HPA translation and inserts the translation into TLB 320 and external TLB 330 via fill line 355. Referring now to Table 2, shown is an example code portion showing the transfer of control between guest TLB handler 370 and virtualization intercept handler 350.

TABLE 2

```
Execute Guest TLB handler code;
if (Guest ITC (GVA, GPA) is intercepted)
  Convert from GPA to HPA;
  Insert a GVA-HPA Translation
    To TLB and VHPT;
  Exit;
```

As above, control then returns to the guest to resume execution.

Thus in various embodiment, MMU (TLB) virtualization may be effected using minimal hardware support (i.e., a processor's virtualization intercept trapping mechanisms and a processor's off-the-shelf page table walker mechanisms). In such manner GPA to HPA translations may be provided without additional hardware custom support. Furthermore, in various embodiments the guest OS may freely access guest page table structures, avoiding the need for complex guest page table tracking algorithms by the VMM. Additionally, embodiments of the present invention may be used without any modification to guest software (e.g., an OS), allowing virtualization environments for shrink-wrap OS's.

Embodiments may be implemented in a computer program. As such, these embodiments may be stored on a storage medium having stored thereon instructions which can be used to program a system to perform the embodiments. The storage medium may include, but is not limited to, any type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic RAMs (DRAMs), erasable programmable read-only memories (EPROMs), electrically erasable programmable read-only memories (EEPROMs), flash memories, magnetic or optical cards, or any type of media suitable for storing electronic instructions. Similarly, embodiments may be implemented as software modules executed by a programmable control device, such as a computer processor or a custom designed state machine.

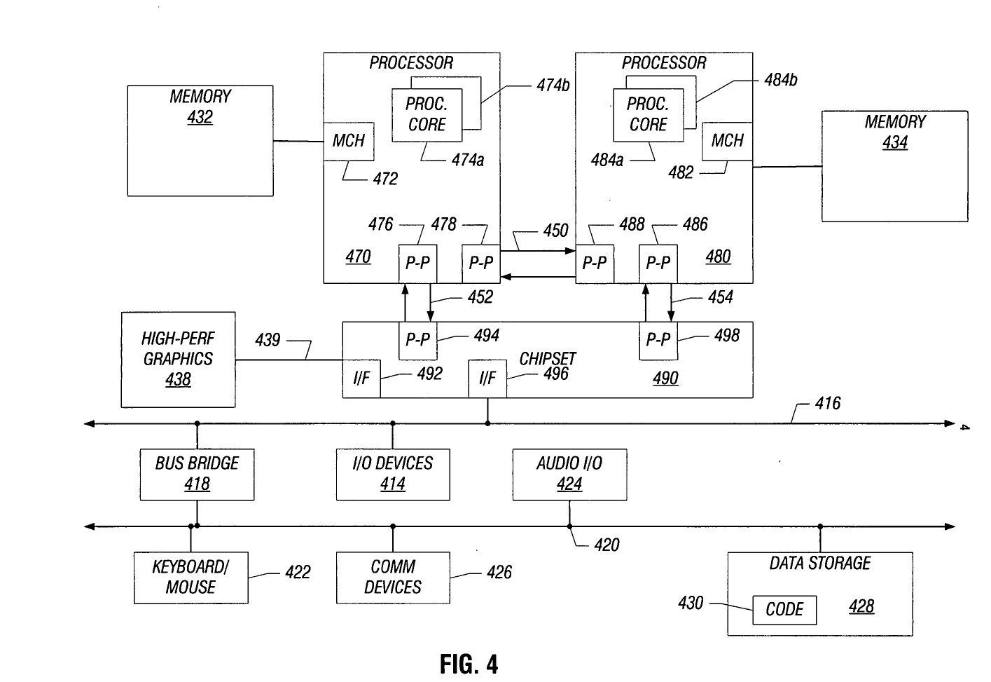

Referring now to FIG. 4, shown is a block diagram of a multiprocessor system in accordance with another embodiment of the present invention. As shown in FIG. 4, the multiprocessor system is a point-to-point bus system, and includes a first processor 470 and a second processor 480 coupled via a point-to-point interconnect 450. As shown in FIG. 4, each of processors 470 and 480 may be multicore processors, including first and second processor cores (i.e., processor cores 474a and b and processor cores 484a and b). First processor 470 further includes a memory controller hub (MCH) 472 and point-to-point (P-P) interfaces 476 and 478. Similarly, second processor 480 includes a MCH 482, and P-P interfaces 486 and 488. As shown in FIG. 4, MCH's 472 and 482 couple the processors to respective memories, namely a memory 432 and a memory 434, which may be portions of main memory locally attached to the respective processors.

First processor 470 and second processor 480 may be coupled to a chipset 490 via P-P interfaces 452 and 454, respectively. As shown in FIG. 4, chipset 490 includes P-P interfaces 494 and 498. Furthermore, chipset 490 includes an interface 492 to couple chipset 490 with a high performance graphics engine 438. In one embodiment, an Advanced Graphics Port (AGP) bus 439 may be used to couple graphics engine 438 to chipset 490. AGP bus 439 may conform to the Accelerated Graphics Port Interface Specification, Revision 2.0, published May 4, 1998, by Intel Corporation, Santa Clara, Calif. Alternately, a point-to-point interconnect 439 may couple these components.

In turn, chipset 490 may be coupled to a first bus 416 via an interface 496. In one embodiment, first bus 416 may be a Peripheral Component Interconnect (PCI) bus, as defined by the PCI Local Bus Specification, Production Version, Revision 2.1, dated June 1995 or a bus such as the PCI Express bus or another third generation I/O interconnect bus, although the scope of the present invention is not so limited.

As shown in FIG. 4, various input/output (I/O) devices 414 may be coupled to first bus 416, along with a bus bridge 418 which couples first bus 416 to a second bus 420. In one embodiment, second bus 420 may be a low pin count (LPC) bus. Various devices may be coupled to second bus 420 including, for example, a keyboard/mouse 422, communication devices 426 and a data storage unit 428 which may include code 430, in one embodiment. Further, an audio I/O 424 may be coupled to second bus 420.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
intercepting a guest software execution of a translation insertion operation; and
performing the translation insertion operation using host software.

2. The method of claim 1, further comprising disabling the guest software from using page table mechanisms.

3. The method of claim 1, wherein performing the translation insertion operation further comprises converting from a guest physical address to a host physical address and inserting the host physical address into a translation lookaside buffer (TLB).

4. The method of claim 3, further comprising inserting the host physical address into an external TLB in a system memory.

5. The method of claim 4, further comprising configuring the external TLB in a hash table.

6. The method of claim 1, wherein performing the translation insertion operation comprises emulating a guest page table walk in the host software.

7. An apparatus comprising:
a first buffer to store guest virtual address to host physical address translations;
a second buffer to store guest virtual address to host physical address translations; and
an intercept handler to emulate a page walk mechanism of a guest if a requested translation is not in the first buffer or the second buffer.

8. The apparatus of claim 7, further comprising a guest hash table to store guest virtual address to guest physical address translations.

9. The apparatus of claim 8, further comprising a processor including the first buffer, and wherein the second buffer resides in a memory external to the processor.

10. The apparatus of claim 8, wherein the intercept handler is to provide the requested translation to the first buffer and the second buffer if a match occurs in the guest hash table.

11. An article comprising a machine-accessible medium having instructions that when executed cause a system to:
intercept a virtualization fault of a guest software;
emulate guest code in a virtual machine monitor to obtain a requested address translation; and
insert the requested address translation into a memory accessible by the guest software.

12. The article of claim 11, further comprising instructions that when executed cause the system to return control to the guest software after insertion of the requested address translation.

13. The article of claim 11, further comprising instructions that when executed cause the system to insert the requested address translation into an internal translation lookaside buffer (TLB) and an external TLB, the requested address translation comprising a guest virtual address to a host physical address translation.

14. The article of claim 11, further comprising instructions that when executed cause the system to return control to the guest code for execution of a guest miss handler if the virtual machine monitor does not obtain the requested address translation.

15. The article of claim 14, further comprising instructions that when executed cause the system to intercept the guest miss handler upon an insert translation instruction.

16. The article of claim 15, further comprising instructions that when executed cause the system to obtain the requested address translation in the virtual machine monitor based on information from the insert translation instruction.

17. A system comprising:
a first buffer to store guest virtual address to host physical address translations;
an intercept handler of host software to emulate a page walk mechanism of a guest if a requested translation is not in the first buffer; and
a dynamic random access memory (DRAM) coupled to the first buffer.

18. The system of claim 17, further comprising a second buffer to store guest virtual address to host physical address translations.

19. The system of claim 18, further comprising a third buffer to store guest virtual address to guest physical address translations.

20. The system of claim 18, further comprising a processor including the first buffer, and wherein the second buffer resides in the DRAM.

21. The system of claim 18, wherein the intercept handler is to provide the requested translation to the first buffer and the second buffer.

22. The system of claim 17, wherein guest comprises a shrink-wrap operating system.

23. The system of claim 22, further comprising at least one guest page table structure, wherein the at least one guest page table structure is accessible by the shrink-wrap operating system.
